(19) United States
(12) Patent Application Publication
(10) Pub. No.: US 2011/0302898 A1
(43) Pub. Date: Dec. 15, 2011

(54) BRISTLE ASSEMBLY

(75) Inventor: Glenn Robert Craig, Warwick (AU)

(73) Assignee: David Michel, Leeds (GB)

(21) Appl. No.: 13/157,506

(22) Filed: Jun. 10, 2011

Related U.S. Application Data
(60) Provisional application No. 61/353,802, filed on Jun. 11, 2010.

(51) Int. Cl. A01D 43/02; B26D 7/00; B08B 1/04; A46B 7/10

(52) U.S. Cl. 56/193; 15/88.4; 83/101; 134/6

(57) ABSTRACT

A bristle assembly for performing a working operation, the bristle assembly comprising a central support defining an axis of rotation of the bristle assembly, an elongate bristle attachment member secured relative to the central support, and a plurality of bristles secured relative to the attachment member such that the bristles project outwardly from the central support.

### CROSS-REFERENCE TO RELATED APPLICATION

This application claims the benefit of U.S. Provisional Application No. 61/353,802, filed Jun. 11, 2010, which is incorporated by reference.

### FIELD OF THE INVENTION

This invention relates to a bristle assembly, and apparatus incorporating such a bristle assembly, for performing working operations including in particular but not necessarily operations typically performed on a lawn or on the ground surface.

### BACKGROUND ART

Lawn care involves maintenance such as regular mowing and periodic dethatching. This is particularly the case for lawns used as bowling greens, golf course fairways and putting greens.

With regard to lawn care for bowling greens, it is usual for the lawn to be cut regularly, possibly several times each day in an endeavour to maintain the lawn in an appropriate playing condition. Each cutting operation can also involve several passes over the lawn. Accordingly, the maintenance of a lawn in a playing condition can be a very time consuming procedure.

The need to make several passes over such a lawn during a mowing operation, and to mow the lawn several times each day, arises because of the nature of the equipment used for the mowing operation. Typically, a conventional reel mower is employed for the mowing operation, involving a driven horizontally mounted cutter reel incorporating a number of circumferentially spaced spiral blades. The cutter reel operates in conjunction with a cutter bar, whereby blades of grass are sliced between the cutter bar and the spiral blades moving relative to the cutter bar.

Because of the circumferential spacing between the spiral reels, it is not possible for all blades of grass requiring cutting to be cut in a single pass. Consequently, several passes are required in order to provide a lawn in an appropriate playing condition.

The lawns also require renovation from time to time, which can involve dethatching or “verti-moving”. The dethatching operation is usually performed using a separate machine to a reel mower, or alternatively a conventional reel mower modified by replacement of the cutter reel with an appropriate tool assembly for performing the necessary renovation operation.

An example of a reel and apparatus for performing such working operations is disclosed in WO 2004/049780.

It is against this background that the present invention has been developed.

### SUMMARY OF THE INVENTION

it is an object of the present invention to overcome, or at least ameliorate, one or more of the deficiencies of the prior art mentioned above, or to provide the consumer with a useful or commercial choice.

Other objects and advantages of the present invention will become apparent from the following description, taken in connection with the accompanying drawings, wherein, by way of illustration and example, a preferred embodiment of the present invention is disclosed.

According to a first broad aspect of the present invention there is provided a bristle assembly for performing a working operation, the bristle assembly comprising a central support defining an axis of rotation of the bristle assembly, an elongate bristle attachment member secured relative to the central support, and a plurality of bristles secured relative to the attachment member such that the bristles project outwardly from the central support.

Preferably, the bristle assembly is for performing a working operation on an area of lawn.

Preferably, the outer ends of the bristles cooperate to define a generally cylindrical surface coaxial with the axis of rotation.

It is preferred that the bristles comprise wire bristles. In a particular preferred form, the wire bristles are made from high carbon steel.

Preferably, the bristle attachment member winds through at least 360°. Accordingly the bristle assembly comprises a reel.

it is preferred that the bristle assembly also comprises an elongate retaining member, that the elongate bristle attachment member defines a channel, and that the bristles are secured relative to the attachment member by inserting the bristles and the retaining member into the channel so that the bristles are folded or bent around the retaining member and protrude from the channel. Preferably, the flexible elongate member is a wire.

According to a second broad aspect of the present invention, there is provided an apparatus comprising a bristle assembly according to the first broad aspect of the present invention.

Preferably, the apparatus further comprises a body rotatably supporting the bristle assembly and a drive means for rotating the bristle assembly, the body being supported on two spaced apart ground-engaging means, and the bristle assembly being horizontally disposed between the two ground-engaging means.

Preferably, the drive system comprises a motor cared on the body.

Preferably, the ground-engaging means are rollers.

Preferably, the apparatus further comprises means for selectively adjusting the height of the bristle assembly relative to the two ground-engaging means.

Preferably, the apparatus can perform various functions, including lawn mowing, lawn renovating such as dethatching, ground levelling, sweeping, materials dispersal, and materials collection.

Where the apparatus is required to perform a mowing operation, it preferably has provision for accommodating a cutter bar which co-operates with the reel for shearing blades of glass therebetween.

According to a third broad aspect of the present invention there is provided a cutter assembly comprising a reel according to the first broad aspect of the present invention, and a cutter bar cooperating with the bristle assembly. With this arrangement, the bristles and the cutter bar co-operate for shearing blades of grass therebetween.

According to a fourth broad aspect of the present invention there is provided a mower incorporating a cutter assembly according to the third broad aspect of the present invention.

According to a fifth broad aspect of the present invention there is provided an apparatus for renovating a lawn, the apparatus being characterised in that it incorporates a reel according to the first broad aspect of the invention.

The apparatus is able to renovate a lawn by moving the rotating bristle assembly over the lawn to perform the renovation such as removal of thatch within the lawn. This may require that the bristle assembly be spaced at or above the ground surface in which the lawn is growing. The apparatus may also be used to aggressively renovate the lawn or indeed remove the lawn. In such an arrangement, the bristle assembly would typically be at a level such that the bristle assembly works below the level of the ground surface,

Preferably, the apparatus includes adjustment means for selectively adjusting the height of the bristle assembly with respect to the lawn undergoing renovation.

According to a sixth broad aspect of the present invention there is provided a ground working apparatus characterised in that the ground working apparatus incorporates a ground working tool comprising a bristle assembly according to the first broad aspect of the present invention.

According to a seventh broad aspect of the present invention, there is provided a method for performing a working operation, the method comprising driving the bristle assembly according to the first broad aspect of the present invention about the axis of rotation such that the plurality of bristles operate at or below a surface level of an area.

Preferably, the method is for dethatching an area of lawn, and the bristle assembly is driven about the axis of rotation such that the plurality of bristles operate below the level of the lawn to perform a dethatching operation.

According to further embodiments, the bristles extend radially from the central cylinder at regions along the length of the cylinder not following a helical (or spiral) path. That is, the bristles may extend from annular segments spaced longitudinally along the length of the support cylinder. Alternatively, the bristles may extend from the cylinder to form longitudinal strips of bristles, being spaced apart longitudinally.

### BRIEF DESCRIPTION OF THE DRAWINGS

In order that the invention may be more fully understood and put into practice, a preferred embodiment thereof will now be described with reference to the accompanying drawings, in which:

FIG. 1 is a schematic side view of an apparatus according to a first preferred embodiment of the present invention, with the apparatus being configured to perform a lawn mowing operation;

FIG. 2 is a perspective view of a reel forming part of the apparatus of FIG. 1;

FIG. 3 is a plan view of the reel of FIG. 2;

FIG. 4 is a schematic fragmentary view illustrating the apparatus performing a lawn mowing operation; and

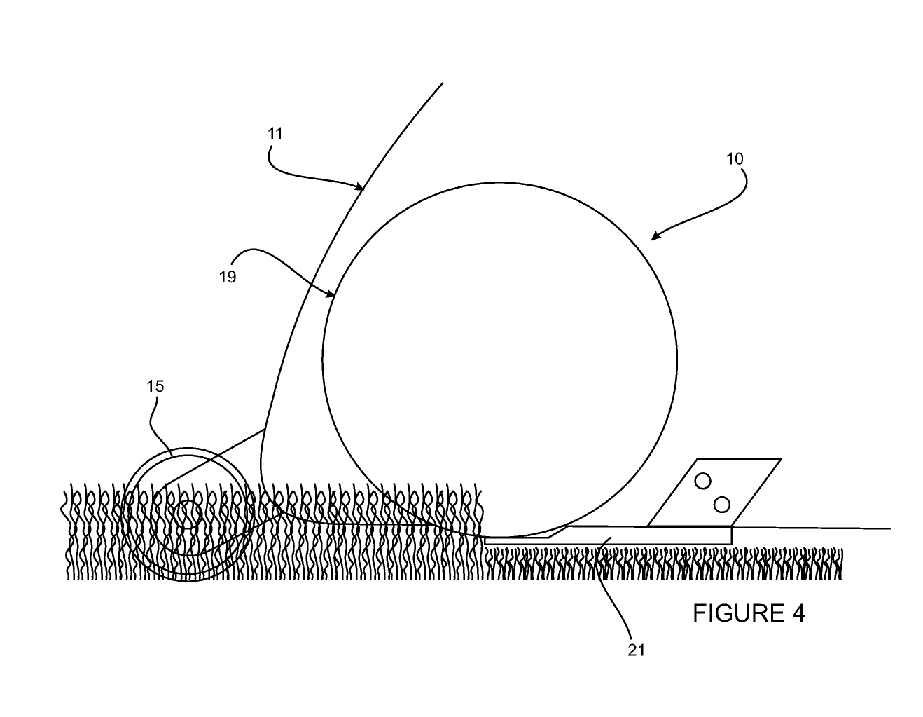

FIG. 5 is a schematic view of the apparatus configured to perform a dethatching operation.

### BEST MODE(S) FOR CARRYING OUT THE INVENTION

Referring to the drawings, the apparatus 10 according to the embodiment is of a construction similar to a conventional reel mower, comprising a body 11 incorporating a handle 13. The body 11 is supported on two ground-engaging means in the form of rollers, being a smaller front roller 15 and a larger rear roller 17. A horizontally disposed reel 19 is supported on the body 11 between the front and rear rollers 15 and 17. The reel 19 is driven by way of a drive system which incorporates a motor 20. A mechanism (not shown) is provided for adjusting the height of the reel 19 relative to the rollers 15 and 17. The apparatus 10 can perform various functions, including lawn mowing, lawn renovating such as dethatching, and ground leveling.

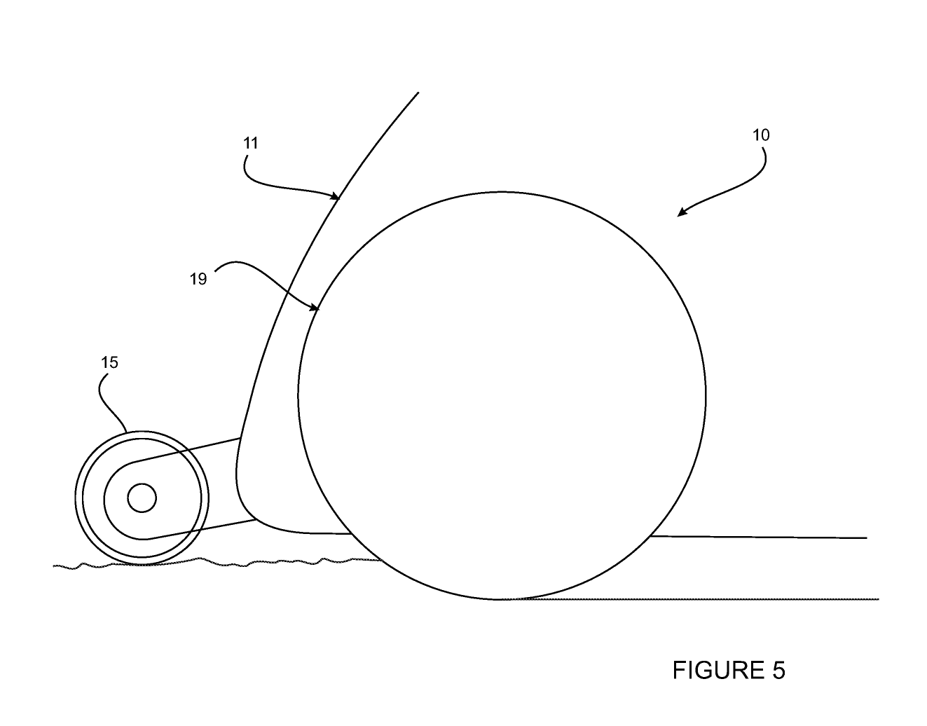

When the apparatus 10 is configured for lawn mowing operations, it is fitted with a cutter bar 21 which operates in association with the reel 19, as will be explained in more detail later. When the apparatus 10 is set up for certain other operations including dethatching, the cutter bar 21 is removed (as shown in FIG. 5).

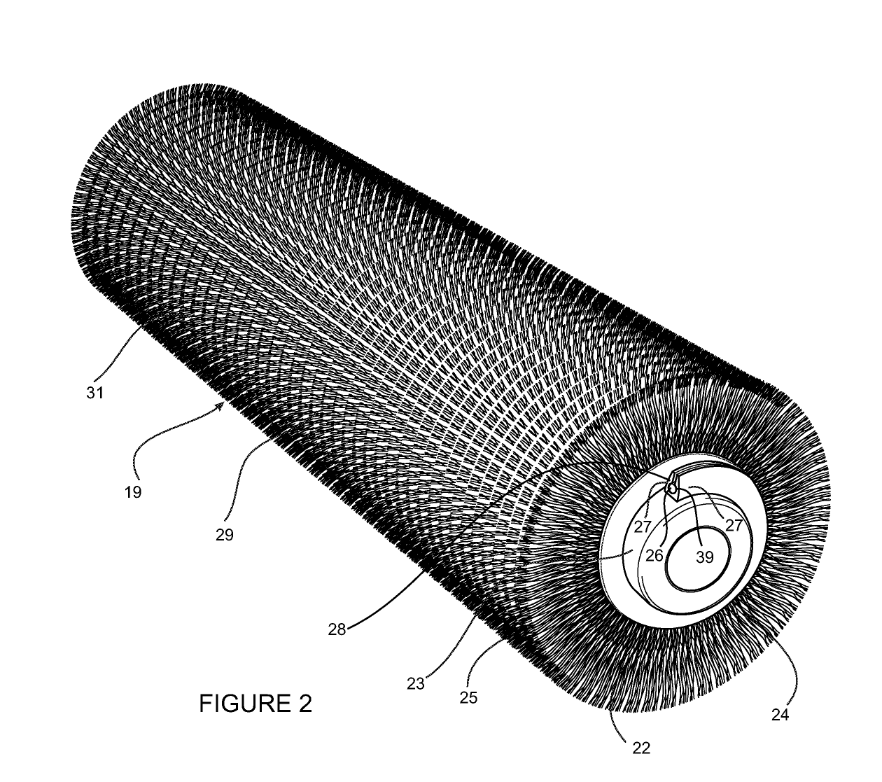

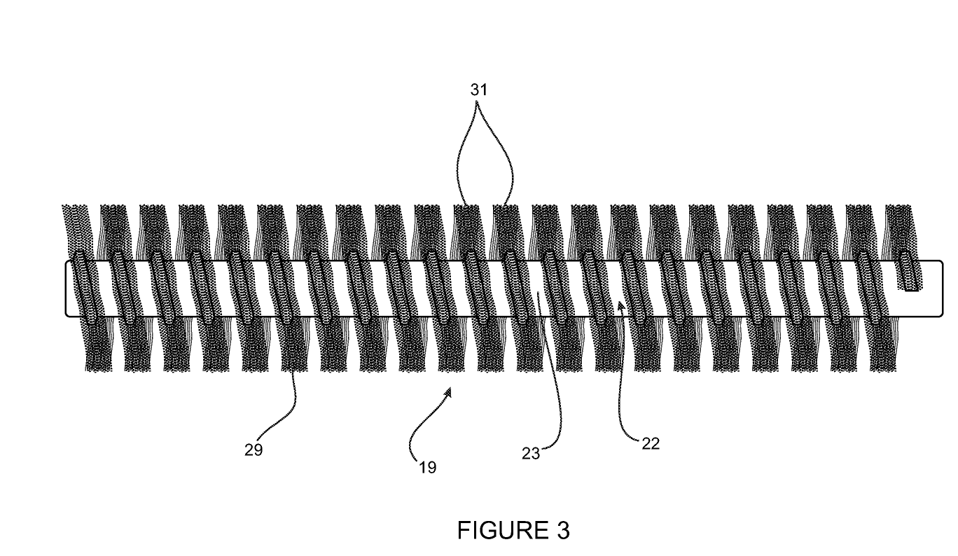

With reference to FIGS. 2 and 3, the reel 19 comprises a central support in the form of a hollow rigid cylinder 23 through which a circular opening 24 extends. The reel 19 is rotatably supported within the body 11 by way of an axle (not depicted) which extends through the opening 24. The reel 19 also includes means (not shown) for receiving rotational drive from the drive system.

The reel 19 further comprises a flexible elongate bristle attachment member 25 which includes a bottom wall 26 and a pair of opposing side was 27 which define a channel 28. Attachment member 25 is wound around the cylinder 23 and is secured to the cylinder 23 such that the member 25 spirals about an axis of rotation of the cylinder 23.

A plurality of bristles 29 are secured relative to the attachment member 25 such that the bristles 29 project radially outward from the cylinder 23 following a helical path along the length of cylinder 23. Accordingly, bristles 29 extend transverse to the axis of cylinder 23. The bristles 29 are preferably secured relative to the attachment member 25 before the member 25 is wound around and secured relative to the cylinder 23. The bristles 29 are secured or retained relative to the member 25 by inserting the bristles 29 and an elongate retaining member in the form of a flexible wire 30 in to the channel 28 so that the bristles 29 are folded or bent around the wire 30, and so that the ends of the bristles 29 protrude from the channel 28. The side was 27 of the channel member 25 are folded or bent towards each other so that the wire 30 is captured within the channel 28 and so that the bristles 29 are pinched or clamped between the side was 27. in this way, the bristles 29 are secured relative to the attachment member 25.

In this embodiment, the cylinder 23, attachment member 25, bristles 29 and wire are all fabricated from a suitable metal. Each bristle 29, in particular, is formed of high carbon steel wire, Additionally, each bristle 29 is crimped along its length.

The outer Ups of the bristles 29 cooperate to define an outer surface 31. Each outer surface 31 is curved, with the centre of curvature corresponding to the rotational axis of the reel 19. The bristles 29 are of substantially the same length such that their outer surfaces 31 generally occupy a substantially common cylindrical plane. In particular, bristles 29 extend radially from cylinder 23 by a distance substantially equal to the diameter of cylinder 23. According to further embodiments, bristles 29 may comprise a length and extend from cylinder by a distance greater than the diameter of cylinder 23.

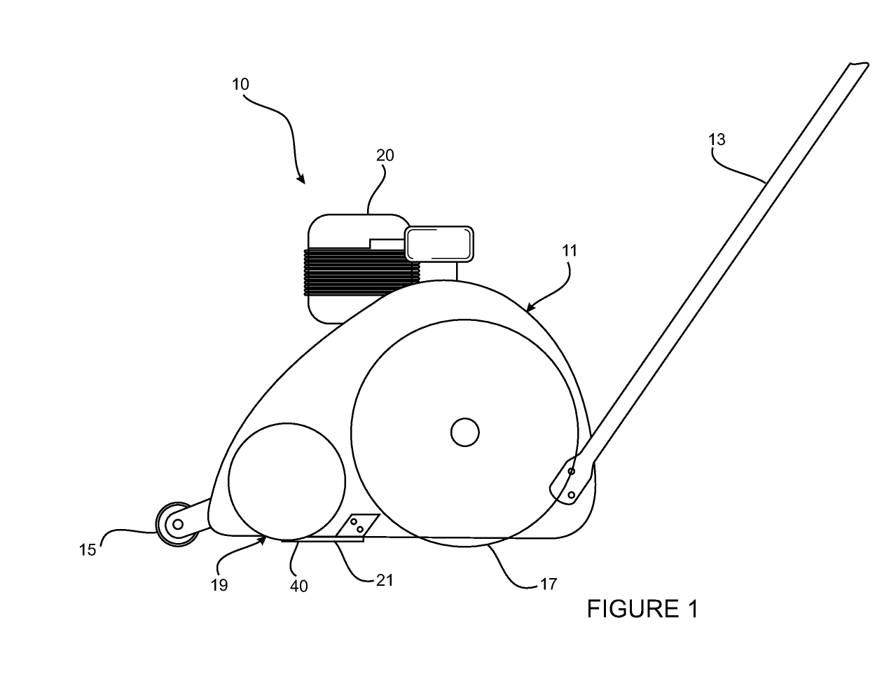

When the apparatus 10 is to perform a lawn mowing function, the reel 19 operates in association with the cutter bar 21, as alluded to earner, The rotating reel 19 is positioned relative to the cutter bar 21 so as to sweep in close contact with the leading edge section of the cutter bar 21. Over a period of time, the cutter bar 21 will wear to conform generally to the circular profile of the outer periphery of the reel 19, such wear being depicted in FIG. 1 of the drawings at zone 40.

The lawn cutting operation is performed by subjecting the grass blades to a shearing action between the cutter bar 21 and the rotating bristles 29. More particularly, a grass blade can be carried by a respective one of the bristles 29 to the cutter bar 21 and then subjected to a shearing action by interaction between the bristle 29 and the cutter bar 21 as the bristle 29 sweeps over the cutter bar 21 during rotation of the reel 19. Because of the multitude of bristles 29 employed in the reel 19, there is little chance of any grass blade not being cut in a single pass of the reel 19. Consequently, a more efficient cutting operation is provided in comparison to that available with a conventional reel having spiral blades which requires at least several passes to perform an appropriate mowing operation.

The bristles 29 on the reel 19 also enhance the grass catching aspect of the mowing operation, as they tend to sweep the cut surface and thus carry cut grass towards a grass catching zone within the apparatus 10.

As mentioned above, the apparatus 10 according to the embodiment can perform working operations other than lawn mowing. One such operation is lawn renovation involving dethatching. To perform such an operation, the cutter bar 21 is removed from the apparatus 10, as shown in FIG. 5. The height of the reel 19 is then adjusted with respect to the front and rear rollers 15, 17 to the desired level according to the nature of the renovation operation to be performed. Where a light renovation is required, the reel 19 can be set relatively high to the lawn surface, with the result that the reel 19 sweeps over the lawn surface to perform the light renovating procedure. On the other hand, where an aggressive renovation is desired, the reel 19 is lowered so as to more aggressively contact the lawn and possibly also soil beneath the lawn.

It has been found that the action of the rotating bristles 29 on the lawn provides a highly effective dethatching action.

The reel 19 can also be used to remove lawn from an area by appropriate setting of the level of the reel 19 with respect to the ground. In such an instance, it is likely that the reel 19 would be set to a level below that of the actual ground surface.

While not shown in the drawings, the apparatus 10 can also be used to perform a ground working operation such as leveling. In such an application, the rotating reel 19 is moved across the area to be worked to remove bumps and crests in the ground surface.

While the invention has been described with reference to one specific embodiment, it is not limited thereto, By way of example,

While the embodiment has been described with reference to bristles 29 formed of steel wire, it should be understood that bristles 29 of any other appropriate material may be employed.

Apparatus according to the invention may also be employed for other operations, including sweeping and materials dispersal (such as snow clearing) utilising the rotating reel. Additionally, apparatus according to the invention may be used for materials collection such as, for example, collection of debris on the ground. In such an application, the rotating reel would be passed over the ground to make contact with the debris and throw it into an associated collection receptacle.

It will be appreciated by those skilled in the art that variations and modifications to the invention described herein will be apparent without departing from the spirit and scope thereof. The variations and modifications as would be apparent to persons skilled in the art are deemed to fall within the broad scope and ambit of the invention as herein set forth.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the term “substantially” or “about” will be understood to not be limited to the value for the range qualified by the terms.

Also, future patent applications maybe filed in Australia or overseas on the basis of, or claiming priority from, the present application. It is to be understood that the following provisional claims are provided by way of example only, and are not intended to limit the scope of what may be claimed in any such future application. Features may be added to or omitted from the provisional claims at a later date so as to further define or re-define the invention or inventions.

It will be clearly understood that, if a prior art publication is referred to herein, that reference does not constitute an admission that the publication forms part of the common general knowledge in the art in Australia or in any other country.

1. A bristle assembly for performing a working operation, the bristle assembly comprising a central support defining an axis of rotation of the bristle assembly, an elongate bristle attachment member secured relative to the central support, and a plurality of bristles secured relative to the attachment member such that the bristles project outwardly from the central support.

2. An apparatus comprising the bristle assembly of claim 1.

3. A cutter assembly comprising the bristle assembly of claim 1, and a cutter bar cooperating with the bristle assembly.

4. A mower incorporating the cutter assembly of claim 3.

5. An apparatus for renovating a lawn, the apparatus being characterised in that it incorporates the bristle assembly according to claim 1.

6. A ground working apparatus characterised in that the ground working apparatus incorporates a ground working tool comprising the bristle assembly of claim 1.

7. A method for performing a working operation, the method comprising driving the bristle assembly of claim 1 about the axis of rotation such that the plurality of bristles operate at or below a surface level of an area.
